(19) United States
(12) Patent Application Publication
(10) Pub. No.: US 2023/0162180 A1
(43) Pub. Date: May 25, 2023

(54) TECHNIQUES FOR TRANSACTIONS ASSOCIATED WITH NON-FUNGIBLE TOKENS (NFT) USING ARTIFICIAL INTELLIGENCE (AI) AND MACHINE LEARNING (ML)

(71) Applicant: Meta Platforms, Inc., Menlo Park, CA (US)

(72) Inventor: Zi Yu Daniel DENG, San Ramon, CA (US)

(73) Assignee: Meta Platforms, Inc., Menlo Park, CA (US)

(21) Appl. No.: 17/456,094

(22) Filed: Nov. 22, 2021

(51) Int. Cl. G06Q 20/38; G06Q 20/06

(52) U.S. Cl. CPC G06Q 20/3823; G06Q 20/3827; G06Q 20/065; G06Q 20/381

(57) ABSTRACT

According to examples, a system for transacting of assets and/or associated non-fungible tokens (NFT) utilizing artificial intelligence (AI) and machine learning (ML) techniques is described. The system may include a processor and a memory storing instructions. The processor, when executing the instructions, may cause the system to identify a candidate asset, generate a transaction asset based on the candidate asset and generate a non-fungible token (NFT) associated with the transaction asset. The processor, when executing the instructions, may then determine a contractual item to facilitate a transaction for the transaction asset and a non-fungible token (NFT) associated with the transaction asset, generate a badge associated with the non-fungible token (NFT) and facilitate a transaction for the transaction asset and the non-fungible token (NFT).

### TECHNICAL FIELD

This patent application relates generally to electronic transactions and electronic commerce, and more specifically, to systems and methods for transacting of assets and/or transactions associated with non-fungible tokens (NFT) utilizing artificial intelligence (AI) and machine learning (ML) techniques.

### BACKGROUND

Blockchain technology is having far-reaching impact and implications in recent years, especially in finance and cryptocurrency. In some examples, a blockchain may include a list of cryptographically associated records (i.e., “blocks”). Such a blockchain may also contain a cryptographic hash of a previous block (i.e., a “chain”). As a result, blockchains are configured to be resistant to modification. In other words, data in any given block of the blockchain may not be altered retroactively without altering all subsequent blocks. For this reason, blockchain technology may be particularly suited for exchange of digital or non-digital assets.

In some instances, use of blockchain technology may include implementation of a “token”. In these instances, the token may be an element of data used to represent and/or transfer assets. In particular, a “non-fungible” token (NFT) may be a unique, tokenized version of an asset that may, in some instances, be particularly useful in identifying and/or authenticating ownership.

Nevertheless, it may still be that non-fungible token (NFT) technology remains underutilized. Indeed, a current lack of access (e.g., by the general public) may have prevented development of a sustainable marketplace for non-fungible token (NFT) assets and may have limited availability of non-fungible tokens (NFT) assets only to entities with special influence or unique access.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIGS. 1A-B illustrate a block diagram of a system environment, including a system, that may facilitate transacting of assets and/or transactions associated non-fungible tokens (NFT) utilizing artificial intelligence (AI) and machine learning (ML) techniques, according to an example.

FIG. 2 illustrates a diagram of a blockchain including a non-fungible token (NFT) block, according to an example.

FIG. 3 illustrates a diagram of a blockchain block, according to an example.

FIG. 4 illustrates a diagram of a user interface of a non-fungible token (NFT) creation page, according to an example.

FIG. 5 illustrates a diagram of a non-fungible token (NFT) package, according to an example.

FIG. 6 illustrates a screen of a user device showing a badge associated with a non-fungible token (NFT), according to an example.

FIG. 7 illustrates a diagram of a badge page associated with a non-fungible token (NFT), according to an example.

FIG. 8 illustrates a diagram of an asset ownership graph (AOG), according to an example.

FIG. 9 illustrates a block diagram of a computer system for transacting of assets and/or transactions associated non-fungible tokens (NFT) utilizing artificial intelligence (AI) and machine learning (ML) techniques, according to an example.

FIG. 10 illustrates a flow diagram of a method for transacting of assets and/or transactions associated non-fungible tokens (NFT) utilizing artificial intelligence (AI) and machine learning (ML) techniques, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

A technology that has had far-reaching impacts in recent years has been blockchain technology. In some examples, a blockchain may include a list of cryptographically associated records (i.e., “blocks”). Blockchains may be implemented as a publicly distributed ledger that may typically be managed by a decentralized, distributed, and peer-to-peer computer-based network.

In some examples, each block may contain a cryptographic hash of the previous block (i.e., a “chain”). As a result, in many instances, blockchains may be resistant to modification as data in any given block may not be altered retroactively without altering all subsequent blocks. Specifically, for a transaction to be written to the blockchain, it must be “validated” via use of network nodes (i.e., “miners”) that may ensure validity of a transaction. Consequently, it may be appreciated that, in some instances, blockchain technology may be particularly suited for exchange of digital or non-digital assets.

In some examples, a blockchain may implement a “smart contract”. In some examples, a smart contract may be a machine-executable contract that may receive an input and, based on the input, may perform a particular action. In some examples, a smart contract may be utilized to govern transfers of goods, services, property and rights.

In some instances, blockchain technology may be utilized to implement use of a “token” to represent and/or transfer digital or non-digital assets. In some examples, a token implemented via blockchain may be fungible or non-fungible. A non-fungible token (NFT) may be a tokenized version of an asset that is unique from other tokens of a same or similar class. It may be appreciated that, in some instances, non-fungible tokens (NFT) may be particularly suited for identification and/or authentication of an asset.

Nevertheless, it may be said that non-fungible token (NFT) technology remains underutilized. Indeed, in many instances, a lack of access by the general public may have prevented development of a sustainable marketplace for non-fungible tokens (NFT). As a result, it may appear that currently availability of non-fungible tokens (NFT) may be limited only to entities with special influence or unique access.

One reason may be that a market for non-fungible tokens (NFT) may be underdeveloped. Indeed, in some instances, the market for non-fungible tokens (NFT) may exhibit an imbalance in supply and demand, wherein the imbalance may be evidenced by a significant number of available non-fungible token (NFT) assets that have no demand (i.e., none or minimal bids). In addition, the imbalance may also be exhibited by a very small number of non-fungible tokens (NFT) that may generate exorbitant sales prices that may, in some instances, appear disassociated from any economic prudence. Consequently, non-fungible tokens (NFT) may often be associated by the general public with “hype” instead of legitimacy.

Another reason may be that a market for non-fungible tokens (NFT) may be incomplete. The market for non-fungible token (NFT) may be incomplete in that various otherwise would-be participants and facilities may be missing. For example, in many instances, it may be difficult to find service providers that may provide non-fungible token (NFT)-related services, resulting in a largely solitary experience for those interested in participating. In addition, in many instances, it may be difficult to find tools (e.g., software) that may aid in utilizing non-fungible token (NFT)-related technology as well. As a result, a demand-to-supply non-fungible token (NFT) “chain” may currently be fragmented into multiple silos, and may lack a seamless, efficient, and end-to-end user experience.

Systems and methods describe transacting of assets and/or associated non-fungible tokens (NFT) utilizing artificial intelligence (AI) and machine learning (ML) techniques. As used herein, an “asset” may include any item or commodity that may be desired by a party (e.g., an individual, a group of individuals). Examples of assets may include digital items such as text, image, video, audio, but may also include non-digital items such as goods, services or real estate. It should be appreciated that, in many instances, the systems and methods may be deployed as part of a content platform (e.g., a social media platform).

In some examples, to provide transacting of assets and/or associated non-fungible tokens (NFT), the systems and methods may analyze various aspects of a candidate asset. As used herein, a “candidate asset” may include any asset that may be analyzed for association with a non-fungible token (NFT).

In some examples, transacting of assets and/or associated non-fungible tokens (NFT) may be determined based on various information associated with a candidate asset. Examples of this various information may include attributes associated with a candidate asset, participants in a market, and a market or market segment that a candidate asset may be associated with.

In some examples, upon determining a candidate asset, the systems and methods may determine and/or generate a transaction asset associated with the candidate asset. As used herein, a “transaction asset” may include any asset that may be associated with a non-fungible token (NFT) for use in a transaction. In some instances, a transaction asset may also be referred to as a “non-fungible token (NFT) asset”. As used herein, a “transacting” and “transaction” may include any activity associated with an asset, wherein examples may include generating, offering (e.g., advertising) and conversion of the asset. So, in some examples, upon determining a transaction asset, the systems and methods may generate (i.e., “mint”) a non-fungible token associated with the transaction asset.

In some examples, the systems and methods may determine and/or generate a transaction asset automatically upon identifying a suitable candidate asset. In other examples, the systems and methods may recommend (e.g., to a particular one or more users) that a candidate asset be considered for non-fungible token (NFT) association. In still other examples, the systems and methods may determine and/or generate an asset upon request.

In some examples, the systems and methods may generate an asset and/or an associated non-fungible token (NFT) automatically as part of a non-fungible token (NFT) “package”. As used herein, a non-fungible token (NFT) package may be a monetizable commodity that may be utilized to stimulate a non-fungible token (NFT) marketplace and increase non-fungible token (NFT) availability.

In some examples, an asset and an associated non-fungible token (NFT) may be associated with a badge. As used herein, a “badge” may include any item of digital data that may be associated with and may identify an asset and/or its non-fungible token (NFT). In particular, in some examples, the badge may be a digital representation of an asset, wherein the badge may be utilized to (among other things) identify the asset as unique. As will be discussed further below, the badge associated with the asset and the non-fungible token (NFT) may be utilized for discovery and sharing of unique assets and generating interaction associated with assets. Indeed, in some examples, a badge may be employed as a “status” symbol that may provide a basis or an incentive to conduct a related transaction.

The systems and methods described may implement a badge in a plethora of settings. For example, in some instances, the systems and methods may incorporate a badge into a content platform (e.g., a social media platform), wherein the badge may represent and/or identify a transaction asset and an associated non-fungible token (NFT) to users of the content platform. In other examples, the systems and methods may implement badges on internet websites and mobile and desktop applications. The systems and methods described may implement a badge for various purposes. Examples include but are not limited to display, marketing, advertising, authentication, conversion and content generation.

In some examples and as will described in further detail below, the systems and methods may improve (i.e., increase) asset and/or associated non-fungible token (NFT) accessibility via seamless non-fungible token (NFT) generation and monetization. In some examples, the systems and methods may provide generation of an asset and/or associated non-fungible token (NFT) that may be included in a holistic non-fungible token (NFT) product (e.g., a non-fungible token (NFT) package). In addition, the systems and methods may also provide tools and interfaces for end-to-end streamlined and seamless user experiences associated with non-fungible token (NFT) asset transactions.

In some examples, the systems and methods may provide asset and non-fungible token (NFT) liquidity (i.e., conversions) by analyzing aspects of a prospective buyer and/or seller to determine a likelihood that each may be interested in a transaction based on the asset. Furthermore, in some examples, the systems and methods described may generate an asset and an associated non-fungible token (NFT), curate a (new and unique) marketplace associated with the asset, and enable a buyer to purchase the asset and the associated non-fungible token (NFT). In addition, in some examples, the systems and methods may enable, among other things, displaying, sharing, tracking, transferring, and transacting of a non-fungible token (NFT) asset during various portions of its “life cycle”. Consequently, in some examples, the systems and methods may provide asset and/or associated non-fungible token (NFT) affordability via scalability and efficiency.

The systems and methods described herein may be implemented in various contexts. In one example, the systems and methods may enable an artist (e.g., a sculptor or painter) to generate a non-fungible token (NFT) associated with a creative work (i.e., an asset) of their creation. In particular, in some examples, the systems and methods may enable the creator to leave a digital, biometric-based (i.e., DNA-based) “signature” associated with the non-fungible token (NFT) that thereafter may be used to prove authenticity and prevent counterfeiting. In another example, pet owners may utilize the systems and methods to generate a non-fungible token (NFT) associated with their pet (i.e., an asset), which may be used to track or monitor the pet to enable animal rescue and prevent pet trafficking.

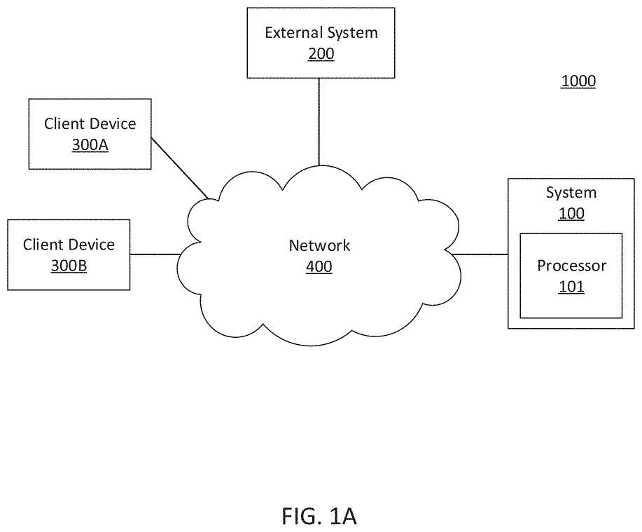

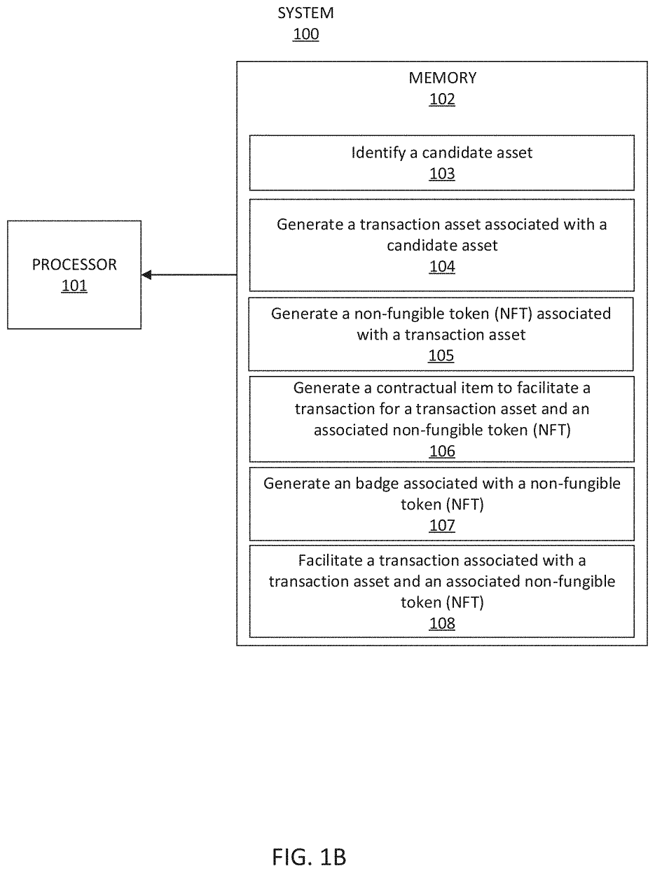

Reference is now made to FIGS. 1A-B. FIG. 1A illustrates a block diagram of a system environment, including a system, that may facilitate transacting of assets and/or transactions associated non-fungible tokens (NFT) utilizing artificial intelligence (AI) and machine learning (ML) techniques. FIG. 1B illustrates a block diagram of the system that may facilitate transacting of assets and/or transactions associated non-fungible tokens (NFT) utilizing artificial intelligence (AI) and machine learning (ML) techniques.

As will be described in the examples below, one or more of system 100, external system 200, user devices 300A-B and system environment 1000 shown in FIGS. 1A-B may be operated by a service provider to transact assets and/or associated non-fungible tokens (NFT). It should be appreciated that one or more of the system 100, the external system 200, the user devices 300A-B and the system environment 1000 depicted in FIGS. 1A-B may be provided as examples. Thus, one or more of the system 100, the external system 200 the user devices 300A-B and the system environment 1000 may or may not include additional features and some of the features described herein may be removed and/or modified without departing from the scopes of the system 100, the external system 200, the user devices 300A-B and the system environment 1000 outlined herein. Moreover, in some examples, the system 100, the external system 200, and/or the user devices 300A-B may be or associated with a social networking system, a content sharing network, an advertisement system, an online system, and/or any other system that facilitates any variety of digital content in personal, social, commercial, financial, and/or enterprise environments.

While the servers, systems, subsystems, and/or other computing devices shown in FIGS. 1A-B may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100, the external system 200, the user devices 300A-B or the system environment 1000.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of potentially personal, private, or sensitive data or information. These and other benefits will be apparent in the descriptions provided herein.

In some examples, the external system 200 may include any number of servers, hosts, systems, and/or databases that store data to be accessed by the system 100, the user devices 300A-B, and/or other network elements (not shown) in the system environment 1000. In addition, in some examples, the servers, hosts, systems, and/or databases of the external system 200 may include one or more storage mediums storing any data. In some examples, and as will be discussed further below, the external system 200 may be utilized to store any information that may relate to transacting of assets and/or associated non-fungible tokens (NFT) (e.g., user histories, preference information, etc.). As will be discussed further below, in other examples, the external system 200 may be utilized by a service provider (e.g., a social media application provider) as part of a data storage, wherein a service provider may access data on the external system 200 to provide transacting of assets and/or associated non-fungible tokens (NFT).

In some examples, and as will be described in further detail below, the user devices 300A-B may be utilized to, among other things, transact for assets and/or associated non-fungible tokens (NFT) as described herein. In some examples, the user devices 300A-B may be electronic or computing devices configured to transmit and/or receive data. In this regard, each of the user devices 300A-B may be any device having computer functionality, such as a television, a radio, a smartphone, a tablet, a laptop, a watch, a desktop, a server, or other computing or entertainment device or appliance. In some examples, the user devices 300A-B may be mobile devices that are communicatively coupled to the network 400 and enabled to interact with various network elements over the network 400. In some examples, the user devices 300A-B may execute an application allowing a user of the user devices 300A-B to interact with various network elements on the network 400. Additionally, the user devices 300A-B may execute a browser or application to enable interaction between the user devices 300A-B and the system 100 via the network 400.

Moreover, in some examples and as will also be discussed further below, the user devices 300A-B may be utilized by a user viewing content (e.g., advertisements) distributed by a service provider, wherein information relating to the user may be stored and transmitted by the user devices 300A to other devices, such as the external system 200. In some examples, and as will described further below, a user may utilize the user device 300A to provide preference information (e.g., a “like”) that may be utilized to recommend an asset and/or associated non-fungible tokens (NFT) to be created. In some examples, a content viewing history of a user utilizing the user device 300B may be utilized to offer an asset and an associated non-fungible token (NFT) for purchase.

The system environment 1000 may also include the network 400. In operation, one or more of the system 100, the external system 200 and the user devices 300A-B may communicate with one or more of the other devices via the network 400. The network 400 may be a local area network (LAN), a wide area network (WAN), the Internet, a cellular network, a cable network, a satellite network, or other network that facilitates communication between, the system 100, the external system 200, the user devices 300A-B and/or any other system, component, or device connected to the network 400. The network 400 may further include one, or any number, of the exemplary types of networks mentioned above operating as a stand-alone network or in cooperation with each other. For example, the network 400 may utilize one or more protocols of one or more clients or servers to which they are communicatively coupled. The network 400 may facilitate transmission of data according to a transmission protocol of any of the devices and/or systems in the network 400. Although the network 400 is depicted as a single network in the system environment 1000 of FIG. 1A, it should be appreciated that, in some examples, the network 400 may include a plurality of interconnected networks as well.

In some examples, and as will be discussed further below, the system 100 may be configured to provide transacting of assets and/or associated non-fungible tokens (NFT) utilizing artificial intelligence (AI) and machine learning (ML) techniques. Details of the system 100 and its operation within the system environment 1000 will be described in more detail below.

As shown in FIGS. 1A-B, the system 100 may include processor 101, a graphics processor unit (GPU) 101a, and the memory 102. In some examples, the processor 101 may be configured to execute the machine-readable instructions stored in the memory 102. It should be appreciated that the processor 101 may be a semiconductor-based microprocessor, a central processing unit (CPU), an application specific integrated circuit (ASIC), a field-programmable gate array (FPGA), and/or other suitable hardware device.

In some examples, the memory 102 may have stored thereon machine-readable instructions (which may also be termed computer-readable instructions) that the processor 101 may execute. The memory 102 may be an electronic, magnetic, optical, or other physical storage device that contains or stores executable instructions. The memory 102 may be, for example, random access memory (RAM), an Electrically Erasable Programmable Read-Only Memory (EEPROM), a storage device, an optical disc, or the like. The memory 102, which may also be referred to as a computer-readable storage medium, may be a non-transitory machine-readable storage medium, where the term “non-transitory” does not encompass transitory propagating signals. It should be appreciated that the memory 102 depicted in FIGS. 1A-B may be provided as an example. Thus, the memory 102 may or may not include additional features, and some of the features described herein may be removed and/or modified without departing from the scope of the memory 102 outlined herein.

It should be appreciated that, and as described further below, the processing performed via the instructions on the memory 102 may or may not be performed, in part or in total, with the aid of other information and data, such as information and data provided by the external system 200 and/or the user devices 300A-B. Moreover, and as described further below, it should be appreciated that the processing performed via the instructions on the memory 102 may or may not be performed, in part or in total, with the aid of or in addition to processing provided by other devices, including for example, the external system 200 and/or the user devices 300A-B.

In some examples, the memory 102 may store instructions, which when executed by the processor 101, may cause the processor to: identify 103 a candidate asset; generate 104 a transaction asset associated with a candidate asset; generate 105 a non-fungible token (NFT) associated with a transaction asset; determine 106 a contractual item to facilitate a transaction for a transaction asset and an associated non-fungible token (NFT); generate 107 a badge associated with a non-fungible token (NFT); and facilitate 108 a transaction associated with a transaction asset and an associated non-fungible token (NFT).

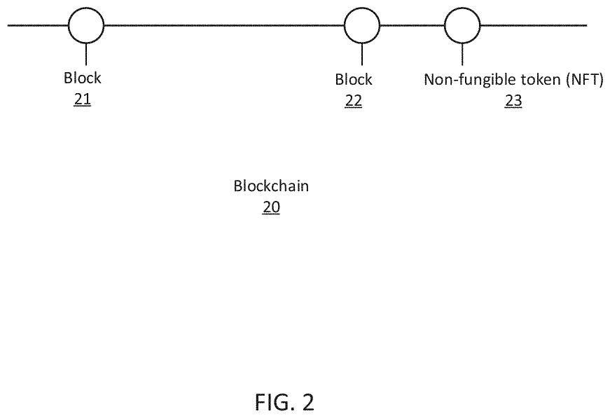

An example of a blockchain 20 including a non-fungible token (NFT) block 23 is illustrated in FIG. 2. In some examples, the blockchain 20 may include a block 21, a block 22 and the non-fungible token (NFT) block 23. It should be appreciated that, in some examples, the block 21, the block 22 and the non-fungible token (NFT) block 23 may be added to the blockchain 20 chronologically.

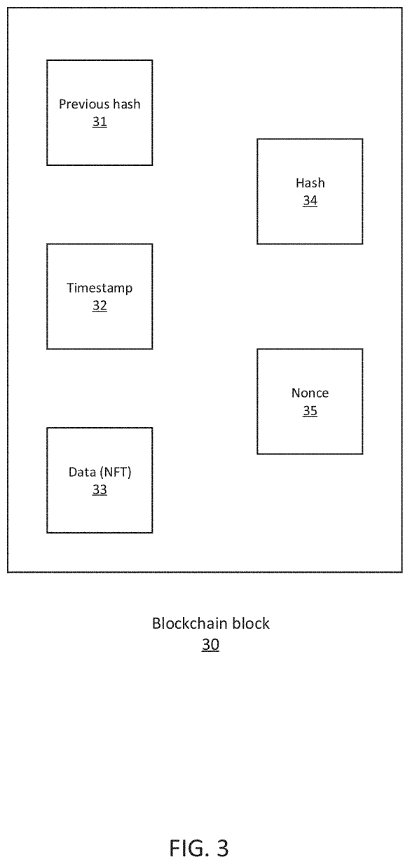

An example of a blockchain block 30 is illustrated in FIG. 3. In some examples, the blockchain block 30 may include various elements, such as previous hash 31, timestamp 32, and data 33. As discussed above, the previous hash 31 may be cryptographic hash of a previous block that may render an associated blockchain resistant to modification. In some examples, the timestamp 31 may indicate time and/or date of creation. In some examples, the data 33 may be a non-fungible token (NFT), such as the non-fungible token (NFT) generated via the instructions 105. In addition, in some examples, the blockchain block 30 may also include hash 34 and nonce 35 as well.

In some examples, and as discussed further below, the instructions 103-108 on the memory 102 may be executed alone or in combination by the processor 101 to provide transacting of assets and/or associated non-fungible tokens (NFT) utilizing artificial intelligence (AI) and machine learning (ML) techniques. In some examples, the instructions 103-108 may be implemented in association with a content platform configured to provide content for users, while in other examples, the instructions 103-108 may be implemented as part of a stand-alone application.

Additionally, and as discussed further below, although not depicted, it should be appreciated that to provide transacting of assets and/or associated non-fungible tokens (NFT), the instructions 103-108 may be configured to utilize various artificial intelligence (AI) and machine learning (ML) based tools. For instance, these artificial intelligence (AI) and machine learning (ML) based tools may be used to generate models that may include a neural network (e.g., a recurrent neural network (RNN)), natural language processing (NLP), a generative adversarial network (GAN), a tree-based model, a Bayesian network, a support vector, clustering, a kernel method, a spline, a knowledge graph, or an ensemble of one or more of these and other techniques. It should also be appreciated that the system 100 may provide other types of machine learning (ML) approaches as well, such as reinforcement learning, feature learning, anomaly detection, etc.

In some examples, the instructions 103 may identify a candidate asset. In some examples and as discussed further below, the instructions 103 may identify the candidate asset to generate a transaction asset and associated non-fungible token (NFT) to be made available for a transaction. Various aspects of identifying a candidate asset via the instructions 103 are discussed further below.

In some examples, the instructions 103 may gather and analyze any information associated with a candidate asset from any source to identify the candidate asset. In particular, in some examples, the instructions 103 may gather information from any electronically available source that may include a content item. As used herein, “content item” may refer to any digital data. Examples of content items include, but are not limited to, digital data, digital images, digital video files, digital audio files, digital text and/or websites, applications, and streaming content.

In some examples, to identify a candidate asset, the instructions 103 may gather and analyze various information associated with the candidate asset. In some instances, the types of various information may each be referred to as “attributes”. In some examples, the identification of the candidate asset may be based on attributes associated with the candidate asset. Examples of such attributes include scarcity, exclusivity and significance associated with the candidate asset. In some instances, the information gathered may be referred to as “signals”.

In some examples, to analyze gathered information associated with a candidate asset, the instructions 103 may implement a particular (computer) model associated with the candidate asset. In some examples, a candidate asset may be analyzed using a model for an associated market space to determine suitability of the candidate asset. So, in one example, an antique clock may be analyzed using a model associated with antiques collectibles.

In some examples, the instructions 104 may analyze information associated with a candidate asset to determine if the candidate asset may be suitable for generation of a non-fungible token (NFT). Examples of various criteria that may be analyzed via the various techniques may include, but are not limited to, significance, rarity, scarcity, and exclusivity (i.e., one-of-kindness). Other criteria may be market-related, such as presence of an exclusive/“niche” (e.g., collector) markets and potential buyers having established interests in related assets. It should be appreciated that the instructions 104 may utilize various artificial intelligence (AI), neural networking (NN) and machine learning (ML) techniques to analyze various information associated with a candidate asset and/or to determine suitability.

In some examples, the instructions 104 may gather and analyze various information associated with participants in a market. Examples of participants include a creator, an owner, a buyer, and a seller (or purchaser). So, in some examples, information (e.g., attributes) associated with a (potential) buyer such as location, demographic information and preference information may be gathered and analyzed.

In some examples, the instructions 104 may gather and analyze various information (e.g., attributes) associated with a market or market segment that a candidate asset may be associated with. Examples of information associated with a market or market segment may include a quantity of similar or same items previously offered for sale and previous sale information for related items. Other examples may include a number of potential interested parties (e.g., buyers) and an association with an exclusive/“niche” (e.g., collector) markets.

In some examples, to determine if a candidate asset may be suitable for non-fungible token (NFT) generation, the instructions 104 may score one or more attributes associated with the candidate asset. So, in one example involving an antique clock being discussed on a group conversation in a social media forum, the instructions 104 may gather and analyze information such as “likes”, “shares” and comments to analyze the item's popularity (i.e., an attribute). In some examples, the instructions 104 may determine a score (i.e., an “attribute score”) that may be utilized to determine the candidate asset's suitability. Also, in some examples, the instructions 104 may analyze attributes of various other assets to determine a degree of similarity (i.e., “look-alike” items) to generate a likelihood that a candidate asset should be associated with a non-fungible token (NFT). In some examples, the likelihood may include and/or may be based on an estimated price, estimated popularity, target audience or audiences, target market or market segment, target geographic region, target seasonality, and optimal timing(s) as well.

In some examples, to determine if a candidate asset may be suitable for non-fungible token (NFT) generation, the instructions 104 may utilize or implement a threshold. So, in one example, the instructions 104 may determine that an antique clock only having a certain number (i.e., a threshold) of likes or shares may be analyzed.

Also, in some examples, the instructions 104 may implement a model that may utilize specified weights to prioritize certain attributes over others. So, in some examples, if it may be appropriate to prioritize a first attribute (e.g., rarity) over a second attribute (e.g., popularity), the instructions 104 may determine and/or assign a higher weight value to the first attribute over the second attribute to analyze the candidate asset.

In some examples, to determine a candidate asset's suitability, the instructions 104 may generate a suitability score for the candidate asset. In some examples, the instructions 104 may also utilize these suitability scores to determine a ranking. Furthermore, in some examples, the ranking may be used to determine suitable candidate assets. So, in one example involving a plurality of antique clocks analyzed according to a model associated with antiques, the instructions 104 may determine that a top ten or a top ten percentile of the plurality of antique clocks may be a basis for a transaction asset and/or non-fungible token (NFT) package. Also, in some examples, generation of a suitability score for a candidate asset may include analysis of previous sales or similar items, generation of pricing estimations and/or recommendations (along with corresponding confidence levels), target audience or audiences, target market or market segment, target geographic region, target seasonality, and optimal timing(s) as well

In addition, in some examples, upon determining a candidate asset's suitability score, the instructions 104 may adjust the suitability score based on various criteria and considerations. That is, in some examples, an (e.g., numerical) adjustment may be made to a generated suitability to address and/or account for a particular situation or circumstance. For example, in some examples, upon determining a suitability score for the candidate asset, the suitability score may be adjusted based on a geographic region or location that the candidate asset may be associated with. In other examples, the suitability score for the candidate asset may be adjusted for other criteria such as seasonality and time (e.g., time of day) as well.

In some examples, the instructions 104 may generate a transaction asset associated with a candidate asset. In particular, in some examples, upon determining that the candidate asset may be suitable, the instructions 104 may utilize the candidate asset to generate a transaction asset. It should be appreciated that to generate the transaction asset, the instructions 104 may utilize various computer-implemented techniques, including natural language processing (NLP), artificial intelligence (AI) and deep learning techniques. Various aspects of generating a transaction asset via the instructions 104 are discussed further below.

In some examples, the instructions 104 may generate a transaction asset that may be a modified version of a candidate asset. More specifically, in some examples, the instructions 104 may utilize some or all of a candidate asset to generate a transaction asset based on the candidate asset. So, in one example where a candidate asset may be a content item (e.g., a video about an antique clock) posted to a content platform (e.g., a social media platform), the instructions 104 may determine that an image, a video and a description of the content item may be utilized to generate a transaction asset. In other examples, the instructions 104 may not modify the candidate asset at all to generate the transaction asset (i.e., they are same).

In some examples, the instructions 104 may generate a transaction asset automatically upon determining that a candidate asset may be suitable. In other examples, the instructions 104 may generate a transaction asset upon request (e.g., by an owner or creator). And in still other examples, the instructions 104 may provide a recommendation that a transaction asset be created. So, in an example involving a social media platform post from an influencer, the instructions 104 may recommend that a video and a description from the social media posting be utilized to generate a transaction asset. In this example, the instructions 104 may generate a recommendation to be sent to the influencer via a recommendation communication (e.g., an email). In some examples, upon receiving a confirmation or affirmation from the influencer, the instructions 104 may generate the transaction asset.

In some examples, the instructions 104 may generate variations of a candidate asset that may be used to create a transaction asset. So, in some examples, the instructions 104 may provide (e.g., via a non-fungible token (NFT) creation page) one or more variations of a candidate asset to a user (e.g., a prospective owner/seller), wherein the instructions 104 may receive preference information (e.g., a selection) that may be used to create a transaction asset. Examples of variations that may be provided may be based on variations in colors, shapes, text, music and placement. It should be appreciated that to generate the variations, deep learning and artificial intelligence (AI) techniques may be implemented by the instructions 104.

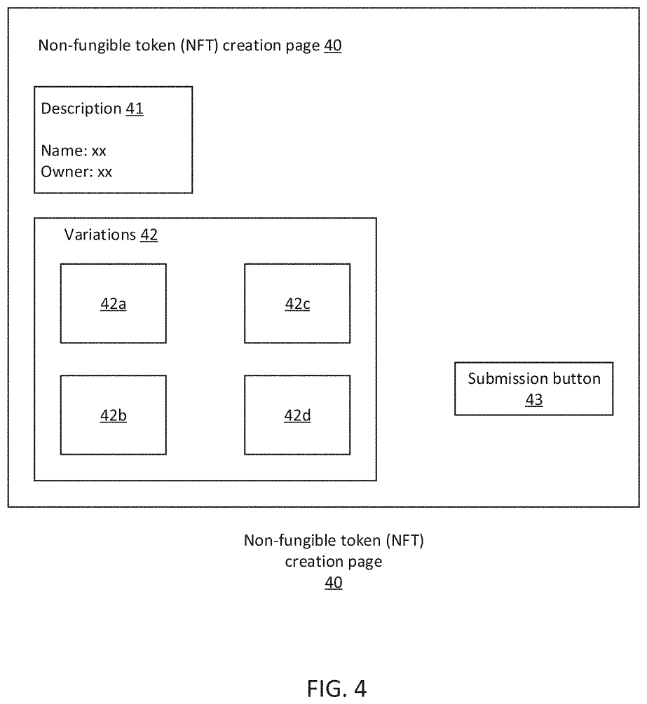

An example of a user interface of a non-fungible token (NFT) creation page 40 is illustrated in FIG. 4. In some examples, the non-fungible token (NFT) creation page 40 may include an information portion 41, a variation selection portion 42 and a submission button 43. In some examples, the information portion 41 may include information such as name of an associated transaction asset and an owner/creator of the associated transaction asset. Furthermore, in some examples, the variation selection portion 42 may include variations of the transaction asset that the user may select from. In some examples, the variation selection portion 42 may include variation 42a, 42b, 42c and 42d. In some example, an owner/creator of the transaction asset may select (e.g., via a mouse-click) a preferred variation, and may select the submission button 43 thereafter to create the transaction asset.

Returning now to FIG. 1B, in some examples, the instructions 104 may enable modifications (e.g., by a creator or owner) to a candidate asset prior to generation of a transaction asset. For example, in some instances, the instructions 104 may enable a party (e.g., a creator or seller) to input modifications to the candidate asset (e.g., via a user interface) that may be utilized to generate the transaction asset. In some examples, the instructions 104 may enable a preview (e.g., a visual or audio preview) that may be utilized by the prospective owner/seller to submit the preference information.

In some examples, the instructions 104 may implement various sampling techniques. In particular, the instructions 104 may implement the sampling techniques to generate information (e.g., feedback) that may be utilized to generate a transaction asset based on a candidate asset. Examples of the sampling techniques implemented by the instructions 104 may include polls, surveys, and questionnaires. So, in one example, the instructions 104 may utilize results (i.e., feedback) from various sampling techniques (e.g., A/B testing) to select one or more variation(s) among a plurality of variations of a candidate asset, and may recommend the one or more selected variations as candidates for transaction asset.

In some examples, as part of implementing various sampling methods, the instructions 104 may also utilize crowdsourcing (e.g., on social media) that may enable gathering of “distributed” feedback (e.g., appraisals) associated with a candidate asset. In some examples, the crowdsourced feedback may then be used to generate a transaction asset, provide price discovery and generate synthesized price recommendations. In some examples, the instructions 104 may record various associated information, such as the crowdsourced feedback on a blockchain ledger (i.e., “on-chain”) of a non-fungible token (NFT) or on an external storage device (i.e., “off-chain”), such as the external system 200.

In some examples, the instructions 105 may generate a non-fungible token (NFT) associated with a transaction asset. As discussed above, in some examples, the associated non-fungible token (NFT) may be generated (i.e., “born”) to represent and/or authenticate one or more aspects (e.g., ownership) of the transaction asset. Various aspects of generating a non-fungible token (NFT) associated with a transaction asset via the instructions 105 are discussed further below.

In some examples, the non-fungible token (NFT) may be generated concurrently with the transaction asset. In other examples, the non-fungible token (NFT) may be generated prior to generation of the transaction asset or generated after generation of the transaction asset.

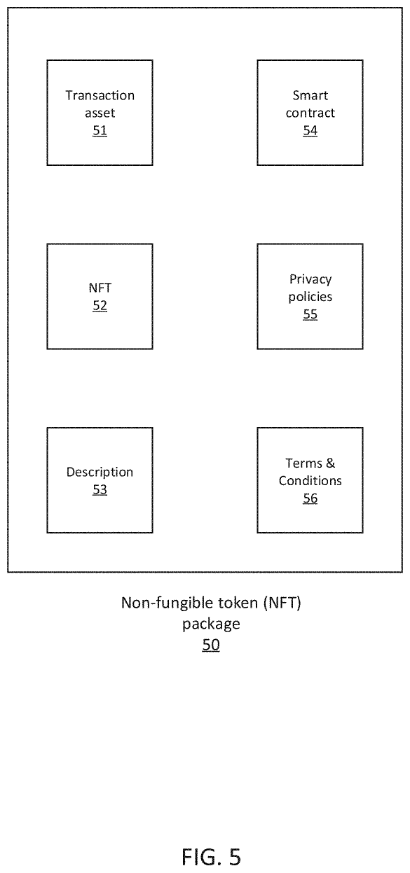

In some examples, upon generation, the instructions 105 may utilize a transaction asset and an associated non-fungible token (NFT) to generate a non-fungible token (NFT) package (as discussed above) associated with the transaction asset. An example of a non-fungible token (NFT) package 500 is illustrated in FIG. 5. In some examples, the non-fungible token (NFT) package 50 may include a transaction asset 51, a non-fungible token (NFT) 52, and a description 53. In particular, in some examples where the transaction asset 51 may be a digital asset, the transaction asset may be included in the non-fungible token (NFT) package 50. Furthermore, the description 53 may include information related to the transaction asset 51 and/or the non-fungible token (NFT) 52. In addition, the non-fungible token (NFT) package 50 may also include a smart contract 54, a privacy policy 55 and terms & conditions 56. In some examples, the privacy policy 55 may limit access to the non-fungible token (NFT) package 50, and the terms & conditions 56 may describe and/or enforce aspects of usage.

It should be appreciated that a non-fungible token (NFT) package generated via the instructions 105 may also include various other information, such as an associated description of contents, a smart contract, policies (e.g., privacy policies) and terms and conditions.

In some examples, the instructions 106 may generate a contractual item to facilitate a transaction for a transaction asset and an associated non-fungible token (NFT). As used herein, a “contractual item” may relate to any aspect related to a transaction asset that may be specified with regard to a transaction (e.g., a purchase or sale). Various aspects of generating a contractual item to facilitate a transaction for a transaction asset via the instructions 106 are discussed further below.

Examples of contractual items that may be generated via the instructions 106 include specifications, terms and conditions that may be utilized to facilitate a transaction of a transaction asset. An example of a specification may be a suggested price or price range that may be associated with the transaction asset (e.g., based on analyzing sale information related to similar assets). An example of a term that may be provided via the instructions may be an expiration date of an offer. An example of a condition may be a restriction in a manner of use that may be required of a buyer. In some examples, the contractual item(s) generated by the instructions 106 may be specified either automatically (e.g., via the instructions 106) or in combination with input from an associated party (e.g., a prospective owner/seller).

In some examples, the instructions 106 may utilize a contractual item to generate a contract. In some examples, the generated contract may be a smart contract. Furthermore, in some examples, the smart contract may be recorded in a (blockchain) ledger of a non-fungible token (NFT) associated with the transaction asset. Examples of specifications, terms and conditions that may be implemented via use of smart contract are discussed further below.

In some examples, the instructions 106 may provide aspects related to ownership of a transaction asset. It should be appreciated that, in some instances, ownership of a transaction asset may include one or more parties. So, in a first example, the instructions 106 may generate a contractual item to administer ownership to be held by one party (e.g., a content creator). In another example, the instructions 106 may generate a contractual item to administer ownership to be held by multiple parties (e.g., creators), wherein the instructions 106 may determine and/or devise an ownership structure to be implemented amongst the multiple parties. In yet another example, ownership may be administered by the instructions 106 to be held by one or more creators of the transaction asset along with a service provider (e.g., a social media platform provider operating the system 100).

In some examples, the instructions 106 may provide transactional aspects associated with a transaction asset. Examples of the transactional aspects that may be provided by the instructions 106 include workflows, marketing (e.g., marketing plans), advertising (e.g., an advertising plan) and conditions for sale (e.g., bidding criteria, etc.). So, in some examples, the instructions 106 may implement a smart contract to (among other things) facilitate fulfillment of terms and conditions, track and prompt interactions by and between parties and secure completion of any predefined criteria and/or benchmarks may be necessary to complete a transaction.

In some examples, the instructions 106 may generate a contractual item that may provide a recommended budget for activities associated with a transaction for a transaction asset. Examples of these activities include an outreach plan (e.g., an advertising plan, a marketing plan) for the transaction asset. So, in some examples, a smart contract implemented by the instructions 106 may determine and/or administer a budget for an advertising plan to secure execution of the advertising plan. In some examples, the smart contract implemented by the instructions 106 may administer the advertising plan on a continuing basis (e.g., monthly or transactional), while in other examples the smart contract implemented by the instructions 106 may enable setting of a percentage of an (eventual) sale amount for an associated transaction asset.

In some examples, the instructions 106 may generate a contractual item to enable distribution of proceeds generated by a transaction asset to one or more parties. In some examples, the instructions 106 may provide distribution according to terms set out in a smart contract. In some examples, the instructions 106 may generate a contractual item to address transaction fees (e.g., transportation costs), which one or more blockchains to be utilized or excluded, which (user) wallets may be whitelisted (i.e., acceptable) or blacklisted (i.e., unacceptable), and default transaction practices (e.g., criteria, behavior, etc.). Furthermore, in some examples, the instructions 106 may utilize one or more contractual items to provide “end-to-end” transactional asset and associated non-fungible token (NFT) management, including minting, transacting and burning.

In some examples, the instructions 106 may generate a smart contract that may enable a third party to participate in generation of a transaction asset. For example, in some instances, the instructions 106 may utilize a smart contract to enable (i.e., administer) a third party to generate (i.e., create) the transaction asset, while in other instances, the instructions 106 may enable modifications to the transaction asset by the third party. In some examples, the instructions 106 may enable a prospective owner/seller to communicate with a third party as well.

In some examples, the instructions 106 may provide information related to a transaction asset to be created in an information package associated with the transaction asset. In some instances, the information package may also be referred to as an “information kit”, and may include any information, items and parameters that may be utilized in generation and/or modification of the transaction asset. In some examples, the instructions 106 may provide the information package to enable a third party to preview or view related items and parameters, and if the third party may be interested, may enable the third party to provide an indication of interest. In some examples, the indication may take the form of a bid (i.e., offer). In some instances, a bidding format may be administered by a smart contract implemented by the instructions 106, and may further enable the third party to receive compensation based on a transaction for the transaction asset (e.g., upon a sale).

In some examples, the instructions 107 may generate a badge associated with a non-fungible token (NFT). As discussed above, in some examples, the badge may identify (e.g., advertise) and/or authenticate a transaction asset and an associated non-fungible token (NFT), and may also facilitate a transaction associated with transaction asset. Various aspects of generating a badge associated with a non-fungible token (NFT) via the instructions 107 are discussed further below.

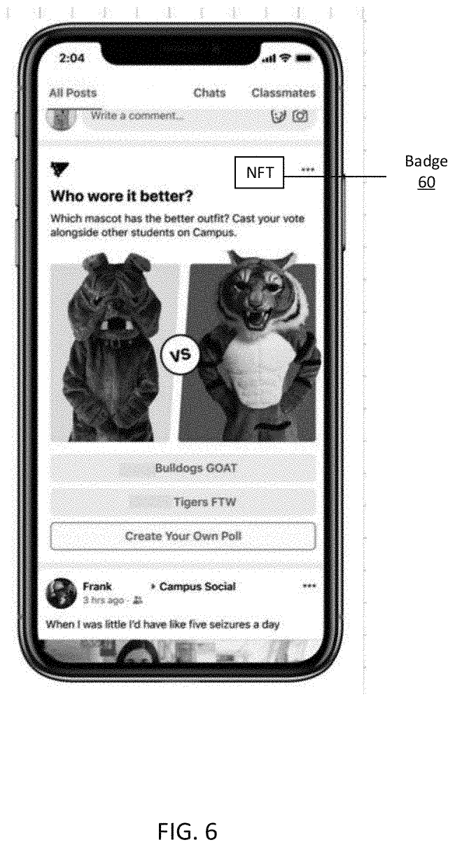

An example of a screen of a user device including a badge 60 associated with a non-fungible token (NFT) is illustrated in FIG. 6. In some examples, the badge 60 may be a selectable user interface element (e.g., an image, a bitmap image (GIF), etc.).

Returning now to FIG. 1B, in some examples, the badge generated via the instructions 107 may be based on some or all of a transaction asset (e.g., using content from the transaction asset itself) or an associated non-fungible token (NFT). In other examples, the badge may be generated independent of the associated transaction asset or the associated non-fungible token (NFT). So, in some examples, the badge generated by the instructions 107 may be based on a variation of the transaction asset, such as the variations generated via the instructions 104. Examples of badges that may be generated by the instruction 107 include images, video content, audio content and icons (e.g., selectable icons).

In some examples, the instructions 107 may generate a badge automatically (e.g., as part of a non-fungible token (NFT) package), and in other examples, the instructions 107 may generate a badge upon request. Also, in some examples, the instructions 107 may generate a badge to be included in or as part of a non-fungible token (NFT) package. In some examples, a badge generated via the instructions 107 may be associated with (e.g., may reference) any type of non-fungible token (NFT). In some examples, a badge generated via the instructions 107 may be associated with any type of blockchain ledger, whether public or private.

In some examples, the instructions 107 may generate a badge to provide and/or represent an ownership interest in an associated transaction asset. That is, in some examples, the instructions 107 may generate the badge to enable an owner of a transaction asset to display ownership in a variety of contexts and locations. Examples of the variety of contexts include, but are not limited to, display, advertising and authentication. Examples of the variety of locations may include, but are not limited to, content platforms, applications (e.g., email), and internet websites & chatrooms.

In addition, the instructions 107 may generate the badge to be utilized in a variety of other contexts as well. Examples of these contexts include, but are not limited to, generating engagement around the transaction asset (i.e., creating a following around the transaction asset) signifying limited or rare aspects of the transaction asset (e.g., a limited edition), and representing significant events or dates (e.g., an upcoming release date for an album). So, in one example, a restaurant may advertise using a badge associated with a social media post related to a unique dinner meal offered on a particular day wherein a user clicking on the badge may review terms and conditions, submit a bid for or purchase the dinner.

So, in some instances, a badge may be present during and/or part of each transaction or activity associated with a transaction asset. Accordingly, in some instances, a badge may be implemented by the instructions 107 to provide a “life cycle” (i.e. a record) for the transaction asset, beginning from creation (i.e., entry in a blockchain based ledger), throughout various transaction stages and ending with “sunset” (i.e., destruction or deletion of the transaction asset). It should be appreciated that, in some examples, display or deployment of a badge may be based on one or more privacy policies associated with the badge. So, in some examples, a first portion of information associated with a badge may be made available publicly, while a second portion of information associated with the badge may be made available only to those satisfying an associated privacy criterion.

In some examples, the instructions 107 may generate a badge to provide access to an associated party (e.g., an owner/seller). That is, in some examples, a user (e.g., a social media platform user) may engage (i.e., click) the badge to access to a particular party (e.g., an owner of the transaction asset and/or non-fungible token (NFT) associated with the badge). In addition, in some examples, the instructions 107 may generate the badge to enable users to “follow” and/or “subscribe”. It should be appreciated that the badge may, in some instances, be subject to and/or may implement various privacy settings and/or policies that may limit access (e.g., to a particular group of users).

In addition, a badge generated by the instructions 107 may be utilized (e.g., by a viewer) to gather information associated with a transaction asset and an associated non-fungible token (NFT). So, in some examples, the instructions 107 may employ the badges in a manner that may enable engagement.

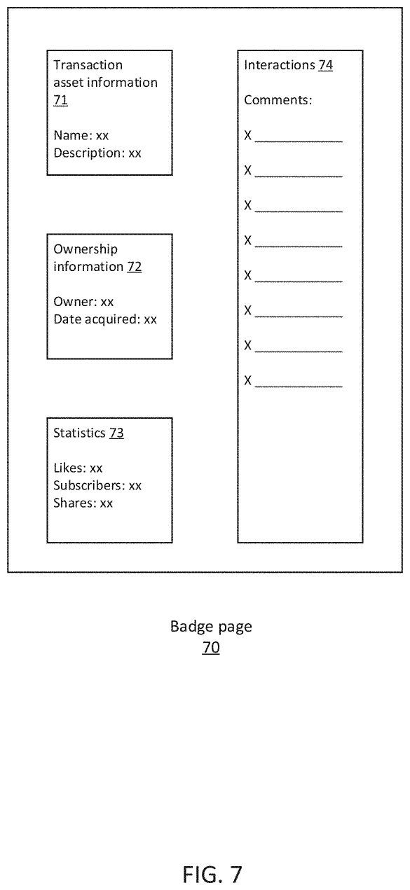

In some examples, upon engagement (e.g., selection) of a badge by a user (e.g., a viewer or prospective buyer), the instructions 107 may provide some or all of information associated with a transaction asset and/or an associated non-fungible token (NFT). For example, in some instances, the instructions 107 may provide this information on a badge “page” or non-fungible token (NFT) “page”. An example badge page 70 associated with a non-fungible token (NFT) is illustrated in FIG. 7. In some examples, the badge page 70 may include transaction asset information 71, ownership information 72, statistics 73 and interactions 74. In some examples, the transaction asset information 71 may provide information associated with the transaction asset, such as name of the transaction asset and a description of the transaction asset. In some examples, the ownership information 72 may include information related to the owner of the transaction asset, such as the owner's name and/or a lineage of owners and date the transaction asset was acquired. In addition, in some examples, the statistics 73 may provide information associated with usage of the badge, such as likes, subscribes and shares. Also, in some examples, the interactions 74 may provide evidence of interactions with users that may have engaged the badge page 70. An example of the interactions 74 may be a comment section. It should be appreciated that the information, such as the information related to engagement (e.g., selections, comments, shares, etc.), associated with the badge may be utilized to for engagement and recommendation purposes. In some examples, the instructions 107 may generate the badge page may display a sequence number of a particular transaction asset and/or associated non-fungible token (NFT) out of a total number (i.e., a limited edition), and further may include one or more links to other related transaction assets and/or non-fungible tokens (NFT) included in the total number (i.e., the limited edition).

Retuning now to FIG. 1B, in some examples, the instructions 107 may enable a badge to be published according to an outreach (e.g., advertising) plan. In some examples, the advertising plan may be administered by a smart contract, wherein the smart contract may administer the advertisement plan according to a budget. In some examples, the budget may be based on a number of badge impressions published, while in other examples, the budget may be based on a number of conversions associated with the badge.

In some examples, the instructions 107 may utilize information associated with engagement of a badge to measure performance of an outreach plan (e.g., an advertising plan or marketing plan). In these examples, the information associated with engagement of the badge (e.g., clicks, conversions) may be tracked and analyzed to modify and/or optimize the advertising plan or the marketing plan, or to generate future advertising or marketing plans.

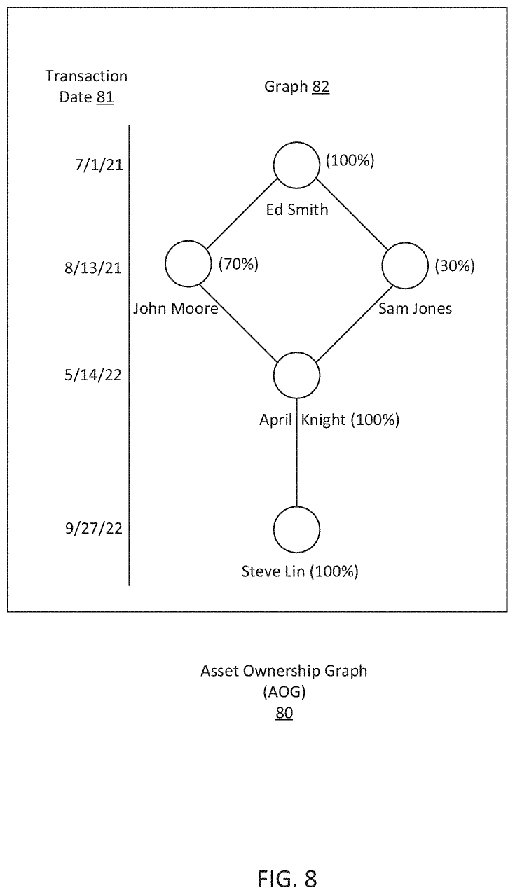

In some examples, the instructions 107 may enable generation of an asset ownership graph (AOG) associated with a badge and/or transaction asset. In some examples, an asset ownership graph may display (any and all) information associated with ownership of an associated transaction asset. In some examples, the asset ownership graph generated via the instructions 107 may provide information related owners of the transaction asset, a chronology of ownership, and purchase price of the transaction asset. Accordingly, in some examples, the badge and/or the asset ownership graph may be utilized to provide a “history” of the transaction asset. An example of an asset ownership graph (AOG) 80 is illustrated in FIG. 8. In some examples, the asset ownership graph 80 may include one or more transaction dates 81 and a graph 82 indicating ownership information.

In some examples, the instructions 107 may generate a badge to be associated with one or more other badges. In these examples, each of the badge and the one or more other badges may be associated (respectively) with a transaction asset. In some examples, the badge and the one or more other badges may be included in (i.e., part of) a plurality (also “wallet”, “box” or “treasure trove”) of badges, wherein the box of badges may be generated by the instruction 107 to indicate that the transaction assets and associated non-fungible tokens (NFT) may be related. Indeed, in some examples, the instructions 107 may enable a user to implement one or more wallets to “hold”, arrange and/or display one or more transaction assets and associated non-fungible tokens (NFT) as a “box” of badges according to various criteria, including timeline, creator, owner, wallet, blockchain, purse, and current values.

So, in some examples, the box of badges may represent a plurality of transaction assets that may be from the same category, while in other examples, the box of badges may represent a plurality of transaction assets that may be from the same creator. As such, in some examples, the box of badges may enable related transaction assets to be engaged in an organized and complete manner.

In some examples, the instructions 108 may facilitate a transaction associated with a transaction asset and an associated non-fungible token (NFT). That is, in some examples, the instructions 108 may facilitate a transaction of a transaction asset by matching one or more interested parties (i.e., potential buyers) with a seller or sellers of the transaction asset in order to complete a transaction (e.g., a conversion, a purchase, etc.). Accordingly, in some examples, the instructions 108 may increase liquidity of in a market for non-fungible token (NFT)-related assets. Various aspects of facilitating a transaction associated with a transaction asset and an associated non-fungible token (NFT) via the instructions 107 are discussed further below.

In some examples, the instructions 108 may “make” a market that may match supply (i.e., sellers) with demand (i.e., buyers). It should be appreciated that numerous sellers may offer a wide variety of transaction assets and that numerous buyers may seek particular transaction assets. In some examples, the instructions 108 may implement various techniques, including artificial intelligence (AI), deep learning, and machine learning (ML) techniques, to match a first party (e.g., a seller) offering a transaction asset to a second party (e.g., a buyer) that may be interested.

In some examples, the instructions 108 may enable a first party (i.e., a seller) to publish information related to a transaction asset. So, in some examples, the instruction 108 may enable the first party to generate and publish information related to the transaction asset and/or an associated non-fungible token (NFT). Example transactions may include a listing, auctions and sales.

It should be appreciated that, in some examples, the instructions 108 may publish information related to a transaction asset in the form of a content item that may be distributed to interested parties (e.g., an advertisement). In some examples, the content item may include text, audio and/or video. So, in one example, the instructions 108 may generate a badge (i.e., a content item) and an associated video related to a transaction asset that may be distributed to various locations on a social media platform for viewing by social media users that may be analyzed to likely be interested. In some examples, the instructions 108 may utilize any information associated with the transaction asset (e.g., information generated and/or accessed via the instructions 103-107) to generate the content item.

In some examples, the instructions 108 may generate and implement an outreach plan to publish information related to a transaction asset. Example outreach plans may include marketing plans and advertising plan. So, in some examples, the instructions 108 may generate an advertising plan that may be implemented to engage other parties with respect to the transaction asset. In particular, in one example, the instructions 108 may implement an advertising plan using one or more social media platforms, wherein one or more content items may be published to engage users on the social media platform with respect to the transaction asset.

In some examples, the instructions 108 may analyze various aspects, including aspects of one or more parties (e.g., prospective buyers) or a transaction asset, to determine an interest in a transaction asset. That is, in some examples, the instructions 108 may analyze various aspects of a party to determine if they may be interested in a transaction asset and/or an associated non-fungible token (NFT). Additional examples of these various aspects that may be analyzed include demographic information (e.g., age, gender, etc.), location (e.g., city or country of residence) and occupation (e.g., student, professional, etc.). In some examples, the instructions 108 may analyze various aspects of the transaction asset (e.g., any information generated and/or accessed via the instructions 103-107) to determine an interest in a transaction asset as well. Examples of the various aspects that may be analyzed include market segment, pricing information, significance and rarity. So, in some examples, the instructions 108 may utilize artificial intelligence (AI), neural networking (NN) and/or machine learning (ML) techniques to calculate a “distance” between various attributes (i.e., attribute vectors) to determine a likelihood that a user or group of users may be interested in a transaction. Furthermore, in some examples, the instructions 108 may determine one or more transaction assets and/or associated non-fungible tokens (NFT) that may be most likely to be of interest to a user or group of users. Also, in some examples, the instructions 108 may further determine one or more similar transaction asset to a given transaction asset (e.g., to display in association with the given transaction asset) as well.

So, in one example relating to a content item about an antique American flag used during World War II, the instructions 108 may analyze aspects to determine prospective buyers of a particular age residing in the United States may be interested. It should be appreciated that to analyze one or more parties and one or more transactions items to determine an interest, various computer-implemented techniques may be utilized, including artificial intelligence (AI), natural language processing (NLP), machine learning (ML) and neural networking (NN) techniques.

In some examples, to engage to an interested party, the instructions 108 may utilize and operate in association with a content platform (e.g., a social media platform). For example, in some instances, the instructions 108 may utilize information from a recommendation algorithm affiliated with a content platform to analyze prospective viewers/buyers. Examples of information that may be made available by a content platform and/or recommendation algorithm may be content preferences (e.g., of prospective buyer and those similarly situated), purchasing histories and trends. So, in one example involving a prospective seller offering an antique clock in association with a non-fungible token (NFT) certifying its authenticity, the instructions 108 may analyze information from the recommendation algorithm to determine that a viewer of related content may likely be interested in the antique clock.

In some examples, upon determining that a party may be interested (e.g., a potential buyer), the instructions 108 may provide (i.e., publish) a content item associated with a transaction asset to the interested party. In some instances, the content item may take the form of an advertisement, wherein the interested party may engage (e.g., select, view) the advertisement to facilitate a transaction. In some examples, an interested party may utilize a content item to convey interest (e.g., select a “Learn more” button). In one example, the content item may be an advertisement (e.g., an image and text) that may be placed by the instructions 108 in a social media “feed” of a user that may be interested in the transaction asset (e.g., explicitly request a transaction asset be associated with a non-fungible token (NFT)).

In some examples, the instructions 108 may facilitate a conversion associated with a transaction asset. As used herein, a “conversion” may include any activity associated with a transaction asset that a first party and a second party may jointly conduct. Examples of conversions include, but are not limited to, purchases, downloads, sales, and responses. In one example, a patient with a particular medical condition may create and own an asset and an associated non-fungible token (NFT) related to her medical records, which may then be sold to an interested buyer (e.g., medical professionals, healthcare providers, drug companies, etc.). It should be appreciated that in some examples and as described further below, the seller patient may implement terms and restrictions of use (e.g., in a smart contract associated with the non-fungible token (NFT)).

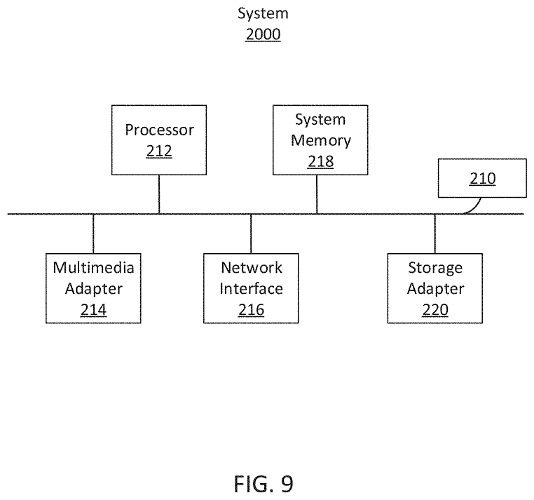

FIG. 9 illustrates a block diagram of a computer system for transacting of assets and/or transactions associated non-fungible tokens (NFT) utilizing artificial intelligence (AI) and machine learning (ML) techniques, according to an example. In some examples, the system 2000 may be associated the system 100 to perform the functions and features described herein. The system 2000 may include, among other things, an interconnect 210, a processor 212, a multimedia adapter 214, a network interface 216, a system memory 218, and a storage adapter 220.

The interconnect 210 may interconnect various subsystems, elements, and/or components of the external system 200. As shown, the interconnect 210 may be an abstraction that may represent any one or more separate physical buses, point-to-point connections, or both, connected by appropriate bridges, adapters, or controllers. In some examples, the interconnect 210 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect 210 may allow data communication between the processor 212 and system memory 218, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 212 may be the central processing unit (CPU) of the computing device and may control overall operation of the computing device. In some examples, the processor 212 may accomplish this by executing software or firmware stored in system memory 218 or other data via the storage adapter 220. The processor 212 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 214 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 216 may provide the computing device with an ability to communicate with a variety of remote devices over a network (e.g., network 400 of FIG. 1A) and may include, for example, an Ethernet adapter, a Fibre Channel adapter, and/or other wired- or wireless-enabled adapter. The network interface 216 may provide a direct or indirect connection from one network element to another, and facilitate communication and between various network elements.

The storage adapter 220 may connect to a standard computer-readable medium for storage and/or retrieval of information, such as a fixed disk drive (internal or external).

Many other devices, components, elements, or subsystems (not shown) may be connected in a similar manner to the interconnect 210 or via a network (e.g., network 400 of FIG. 1A). Conversely, all of the devices shown in FIG. 9 need not be present to practice the present disclosure. The devices and subsystems can be interconnected in different ways from that shown in FIG. 9. Code to implement the dynamic approaches for payment gateway selection and payment transaction processing of the present disclosure may be stored in computer-readable storage media such as one or more of system memory 218 or other storage. Code to implement the dynamic approaches for payment gateway selection and payment transaction processing of the present disclosure may also be received via one or more interfaces and stored in memory. The operating system provided on system 100 may be MS-DOS, MS-WINDOWS, OS/2, OS X, 10S, ANDROID, UNIX, Linux, or another operating system.

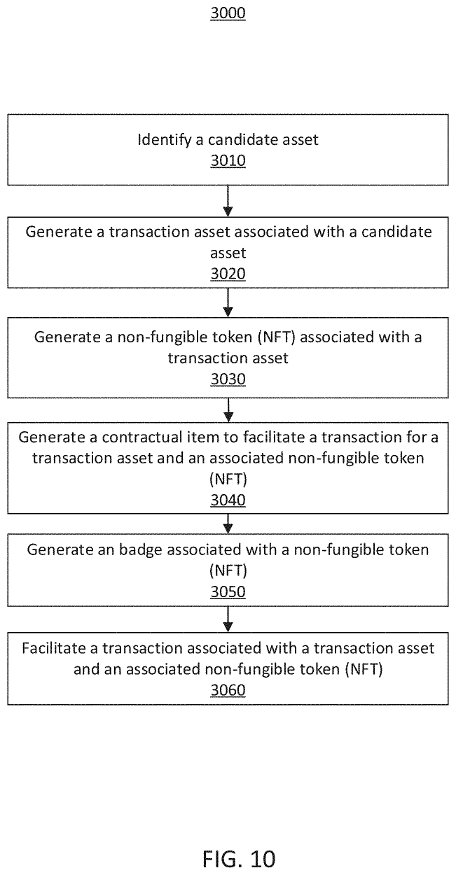

FIG. 10 illustrates a flow diagram of a method for transacting of assets and/or transactions associated non-fungible tokens (NFT) utilizing artificial intelligence (AI) and machine learning (ML) techniques. The method 3000 is provided by way of example, as there may be a variety of ways to carry out the method described herein. Each block shown in FIG. 10 may further represent one or more processes, methods, or subroutines, and one or more of the blocks may include machine-readable instructions stored on a non-transitory computer-readable medium and executed by a processor or other type of processing circuit to perform one or more operations described herein.

Although the method 3000 is primarily described as being performed by system 100 as shown in FIGS. 1A-B, the method 3000 may be executed or otherwise performed by other systems, or a combination of systems. It should be appreciated that, in some examples, to provide transacting of assets and/or associated non-fungible tokens (NFT), the method 3000 may be configured to incorporate artificial intelligence (AI) or deep learning techniques, as described above. It should also be appreciated that, in some examples, the method 3000 may be implemented in conjunction with a content platform (e.g., a social media platform) to generate and deliver content.

Reference is now made with respect to FIG. 10. At 3010, the processor 101 may identify a candidate asset. In particular, in some examples, the processor 101 may gather and analyze various information associated with the candidate asset from any electronically available source. Examples of this various information may include attributes associated with a candidate asset, participants in a market, and a market or market segment that a candidate asset may be associated with. In some examples, the processor 101 may analyze information associated with the candidate asset to determine if the candidate asset may be suitable for generation of a non-fungible token (NFT). In some examples, to determine if a candidate asset may be suitable, the processor 101 may score one or more attributes and implement a computer model associated with the candidate asset.

At 3020, the processor 101 may generate a transaction asset associated with a candidate asset. In some examples, the processor 101 may utilize some or all of the candidate asset to generate the transaction asset, while in other examples, the processor 101 may not modify the candidate asset at all to generate the transaction asset. Also, in some examples, the processor 101 may generate variations of the candidate asset that may be used to create the transaction asset. Furthermore, in some instances, the processor 101 may implement various sampling techniques, including A/B testing and crowdsourcing.

At 3030, the processor 101 may generate a non-fungible token (NFT) associated with a transaction asset. In some examples, the processor 101 may generate the non-fungible token (NFT) concurrently with the transaction asset. In other examples, the processor 101 may generate the non-fungible token (NFT) prior to generation of the transaction asset, or after generation of the transaction asset. In some examples, the transaction asset and the associated non-fungible token (NFT) may be included by the processor 101 in a non-fungible token (NFT) package.

At 3040, the processor 101 may generate a contractual item to facilitate a transaction for a transaction asset and an associated non-fungible token (NFT). Examples of contractual items that may be generated include specifications, terms and conditions that may be utilized to facilitate a transaction of a transaction asset. In some examples, the processor 101 may further utilize a generated contractual item to generate a contract, such as a smart contract. In some examples, the smart contract may be implemented by the processor 101, and may provide ownership aspects and transactional aspects associated with the transaction asset. In addition, in some examples, the processor 101 may generate a contractual item that may provide a recommended budget for activities (e.g., an advertising plan) associated with a transaction for the transaction asset.

At 3050, the processor 101 may generate a badge associated with a non-fungible token (NFT). In some examples, the badge generated via the processor 101 may be based on some or all of an associated transaction asset (e.g., using content from the transaction asset itself) and/or an associated non-fungible token (NFT). In other examples, the badge generated by the processor 101 may be independent of the transaction asset or the associated non-fungible token (NFT). In some examples, the processor 101 may generate the badge to represent an ownership interest in the transaction asset, generate engagement around the transaction asset, and represent significant events or dates.

In some examples, the processor 101 may enable a badge to be published according to an advertising plan. In some examples, the advertising plan may be administered by a smart contract, wherein the smart contract may administer the advertisement plan according to a budget. Furthermore, in some examples, the processor 101 may enable generation of an asset ownership graph (AOG) associated with the badge.

At 3060, In some examples, the processor 101 may facilitate a transaction associated with a transaction asset and an associated non-fungible token (NFT). In some examples, the processor 101 may implement various techniques, including artificial intelligence (AI), deep learning, and machine learning (ML) techniques, to match a first party (e.g., a seller) offering a transaction asset to a second party (e.g., a buyer) that may be interested. In some examples, the processor 101 may generate and implement an advertising plan to publish information related to the transaction asset and further determine if a party (e.g., a potential buyer) may be interested in the transaction asset. Furthermore, in some examples, the processor 101 may facilitate a conversion associated with the transaction asset. Examples of conversions associated with the transaction asset that may be implemented by the processor 101 may include purchases, downloads, sales, and responses.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

It should be noted that the functionality described herein may be subject to one or more privacy policies, described below, enforced by the system 100, the external system 200, and the user devices 300A-B that may bar use of images for concept detection, recommendation, generation, and analysis.

In particular examples, one or more objects of a computing system may be associated with one or more privacy settings. The one or more objects may be stored on or otherwise associated with any suitable computing system or application, such as, for example, the system 100, the external system 200, and the user devices 300A-B, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the system 100, the external system 200, and the user devices 300A-B, or shared with other systems. Although this disclosure describes using particular privacy settings in a particular manner, this disclosure contemplates using any suitable privacy settings in any suitable manner.

In particular examples, the system 100, the external system 200, and the user devices 300A-B may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the system 100, the external system 200, and the user devices 300A-BA-B may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics.

In particular examples, the system 100, the external system 200, and the user devices 300A-BA-B may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the system 100, the external system 200, and the user devices 300A-BA-B may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The system 100, the external system 200, and the user devices 300A-BA-B may access such information in order to provide a particular function or service to the first user, without the system 100, the external system 200, and the user devices 300A-BA-B having access to that information for any other purposes. Before accessing, storing, or using such objects or information, the system 100, the external system 200, and the user devices 300A-BA-B may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the system 100, the external system 200, and the user devices 300A-B.

In particular examples, a user may specify whether particular types of objects or information associated with the first user may be accessed, stored, or used by the system 100, the external system 200, and the user devices 300A-B. As an example and not by way of limitation, the first user may specify that images sent by the first user through the system 100, the external system 200, and the user devices 300A-B may not be stored by the system 100, the external system 200, and the user devices 300A-B. As another example and not by way of limitation, a first user may specify that messages sent from the first user to a particular second user may not be stored by the system 100, the external system 200, and the user devices 300A-B. As yet another example and not by way of limitation, a first user may specify that all objects sent via a particular application may be saved by the system 100, the external system 200, and the user devices 300A-B.

In particular examples, privacy settings may allow a first user to specify whether particular objects or information associated with the first user may be accessed from the system 100, the external system 200, and the user devices 300A-B. The privacy settings may allow the first user to opt in or opt out of having objects or information accessed from a particular device (e.g., the phone book on a user's smart phone), from a particular application (e.g., a messaging app), or from a particular system (e.g., an email server). The system 100, the external system 200, and the user devices 300A-B may provide default privacy settings with respect to each device, system, or application, and/or the first user may be prompted to specify a particular privacy setting for each context. As an example and not by way of limitation, the first user may utilize a location-services feature of the system 100, the external system 200, and the user devices 300A-B to provide recommendations for restaurants or other places in proximity to the user. The first user's default privacy settings may specify that the system 100, the external system 200, and the user devices 300A-B may use location information provided from one of the user devices 300A-B of the first user to provide the location-based services, but that the system 100, the external system 200, and the user devices 300A-B may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The system 100, the external system 200, and the user devices 300A-B may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the system 100, the external system 200, and the user devices 300A-B may use a user's previous activities and calculated moods, emotions, or sentiments to determine a present mood, emotion, or sentiment. A user who wishes to enable this functionality may indicate in their privacy settings that they opt in to the system 100, the external system 200, and the user devices 300A-B receiving the inputs necessary to determine the mood, emotion, or sentiment. As an example and not by way of limitation, the system 100, the external system 200, and the user devices 300A-B may determine that a default privacy setting is to not receive any information necessary for determining mood, emotion, or sentiment until there is an express indication from a user that the system 100, the external system 200, and the user devices 300A-B may do so. By contrast, if a user does not opt in to the system 100, the external system 200, and the user devices 300A-B receiving these inputs (or affirmatively opts out of the system 100, the external system 200, and the user devices 300A-B receiving these inputs), the system 100, the external system 200, and the user devices 300A-B may be prevented from receiving, collecting, logging, or storing these inputs or any information associated with these inputs. In particular examples, the system 100, the external system 200, and the user devices 300A-B may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the system 100, the external system 200, and the user devices 300A-B may use the user's mood, emotion, or sentiment to provide newsfeed items, pages, friends, or advertisements to a user. The user may specify in their privacy settings that the system 100, the external system 200, and the user devices 300A-B may determine the user's mood, emotion, or sentiment. The user may then be asked to provide additional privacy settings to indicate the purposes for which the user's mood, emotion, or sentiment may be used. The user may indicate that the system 100, the external system 200, and the user devices 300A-B may use his or her mood, emotion, or sentiment to provide newsfeed content and recommend pages, but not for recommending friends or advertisements. The system 100, the external system 200, and the user devices 300A-B may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the system 100, the external system 200, and the user devices 300A-B may be restricted in its access, storage, or use of the objects or information. The system 100, the external system 200, and the user devices 300A-B may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the system 100, the external system 200, and the user devices 300A-B may temporarily store the message in a content data store until the second user has viewed or downloaded the message, at which point the system 100, the external system 200, and the user devices 300A-B may delete the message from the data store. As another example and not by way of limitation, continuing with the prior example, the message may be stored for a specified period of time (e.g., 2 weeks), after which point the system 100, the external system 200, and the user devices 300A-B may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the system 100, the external system 200, and the user devices 300A-B may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the system 100, the external system 200, and the user devices 300A-B. The user's privacy settings may specify that such information may be used only for particular processes, such as authentication, and further specify that such information may not be shared with any external system or used for other processes or applications associated with the system 100, the external system 200, and the user devices 300A-B. As another example and not by way of limitation, the system 100, the external system 200, and the user devices 300A-B may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the system 100, the external system 200, and the user devices 300A-B. As another example and not by way of limitation, the system 100, the external system 200, and the user devices 300A-B may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the system 100, the external system 200, and the user devices 300A-B.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The system 100, the external system 200, and the user devices 300A-B may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the system 100, the external system 200, and the user devices 300A-B may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the system 100, the external system 200, and the user devices 300A-B may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the system 100, the external system 200, and the user devices 300A-B may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (e.g., “public”). However, if the user changes his or her relationship status, the system 100, the external system 200, and the user devices 300A-B may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the system 100, the external system 200, and the user devices 300A-B may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the system 100, the external system 200, and the user devices 300A-B may send a reminder to the user to confirm his or her privacy settings every six months or after every ten photo posts. In particular examples, privacy settings may also allow users to control access to the objects or information on a per-request basis. As an example and not by way of limitation, the system 100, the external system 200, and the user devices 300A-B may notify the user whenever an external system attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system, comprising:
a processor; and
a memory storing instructions, which when executed by the processor, cause the processor to:
identify a candidate asset;
generate a transaction asset based on the candidate asset;
generate a non-fungible token (NFT) associated with the transaction asset;
determine a contractual item to facilitate a transaction for the transaction asset and the non-fungible token (NFT);
generate a badge associated with the non-fungible token (NFT); and
facilitate the transaction for the transaction asset and the non-fungible token (NFT).

2. The system of claim 1, wherein to identify the candidate asset, the instructions cause the processor to gather and analyze information associated with the candidate asset to determine if the candidate asset is suitable for non-fungible token (NFT) generation.

3. The system of claim 1, wherein to identify the candidate asset, the instructions cause the processor to gather and analyze information related to an attribute associated with the candidate item and to generate an attribute score.

4. The system of claim 1, wherein to identify the candidate asset, the instructions cause the processor to implement a computer model associated with the candidate asset.

5. The system of claim 1, wherein the transaction asset is a modified version of the candidate asset.

6. A method for transacting of assets and associated non-fungible tokens (NFT), comprising:
identifying a candidate asset;
generating a transaction asset based on the candidate asset;
generating a non-fungible token (NFT) associated with the transaction asset; and
facilitating a transaction for the transaction asset and the non-fungible token (NFT).

7. The method of claim 6, further comprising determining a contractual item to facilitate the transaction for the transaction asset and the non-fungible token (NFT).

8. The method of claim 6, further comprising generating a badge associated with the non-fungible token (NFT).

9. The method of claim 6, wherein identifying the candidate asset includes generating one or more variations of the candidate asset.

10. The method of claim 6, wherein identifying the candidate asset includes enabling a modification to the candidate asset prior to generating the transaction asset.

11. The method of claim 6, wherein identifying the candidate asset includes implementing crowdsourcing to gather distributed feedback associated with the candidate asset.

12. The method of claim 6, further comprising generating a non-fungible token (NFT) package including the transaction asset and the non-fungible token (NFT).

13. A non-transitory computer-readable storage medium having an executable stored thereon, which when executed instructs a processor to:
identify a candidate asset;
generate a transaction asset based on the candidate asset;
generate a non-fungible token (NFT) associated with the transaction asset; and
facilitate a transaction for the transaction asset and the non-fungible token (NFT).

14. The non-transitory computer-readable storage medium of claim 13, wherein the executable when executed further instructs the processor to determine a contractual item to facilitate the transaction for the transaction asset and the non-fungible token (NFT).

15. The non-transitory computer-readable storage medium of claim 14, wherein the executable when executed further instructs the processor to generate a smart contract including the contractual item.

16. The non-transitory computer readable storage medium of claim 15, wherein the smart contract implements an aspects related to ownership of the transaction asset and a budget for an activity associated with the transaction for the transaction asset and the non-fungible token (NFT).

17. The non-transitory computer-readable storage medium of claim 13, wherein the executable when executed further instructs the processor to publish a badge according to an outreach plan and to utilize engagement information associated with the badge to measure performance of the outreach plan.

18. The non-transitory computer-readable storage medium of claim 13, wherein the executable when executed further instructs the processor to generate an asset ownership graph (AOG) associated with the transaction asset.

19. The non-transitory computer-readable storage medium of claim 13, wherein the executable when executed further instructs the processor to facilitate a conversion associated with the transaction asset.

20. The non-transitory computer-readable storage medium of claim 19, wherein the conversion is one of a purchase, a download, a sale and a response.
